(19) United States
(12) Patent Application Publication
(10) Pub. No.: US 2018/0147027 A1
(43) Pub. Date: May 31, 2018

(54) ORTHODONTIC APPLIANCE

(71) Applicant: Sang Gun JANG, Daegu (KR)

(72) Inventor: Sang Gun JANG, Daegu (KR)

(21) Appl. No.: 15/551,027

(22) PCT Filed: Nov. 6, 2015
(86) PCT No.: PCT/KR2015/011949

§ 371 Date: Aug. 14, 2017

(30) Foreign Application Priority Data
Feb. 12, 2015 (KR) 10-2015-0021481

(51) Int. Cl. A61C 7/20; A61C 7/08

(52) U.S. Cl. CPC A61C 7/20; A61C 7/145; A61C 7/08

(57) ABSTRACT

An orthodontic appliance includes an arch wire formed on a trajectory corresponding to an aligned dentition of the lower or upper dentures and installed on the lip side or the tongue side of the dentures. An anchor bracket is fixed on both side molars of the upper or lower dentures, and detachably anchors the arch wire. An adhesive formed in a gel state is cured after being applied to the teeth surface of teeth to be aligned. The adhesive covers the arch wire installed on the anchor bracket to allow the arch wire to move when the teeth to be aligned move. The orthodontic appliance can be easily installed by applying, to the teeth surface, the adhesive covering the arch wire after installing the arch wire in a mouth and can protect the teeth from cavities by applying the adhesive to the teeth surface without existing brackets.

### TECHNICAL FIELD

The present invention relates to an orthodontic appliance and, more particularly, an appliance can easily install an orthodontic appliance by applying, to the teeth surface, the adhesive covering the arch wire installing the adhesive to the teeth surface without existing brackets and can prevent the adhesive from interfering with movement of arch wire by covering the surface of the arch wire with the adhesive after coating the surface of the arch wire with a soluble coating agent.

### BACKGROUND ART

In general, in humans, a tooth is an important factor that produces a personal appearance due to an image externally formed by its color and shape. A set of teeth according to the array of the teeth has been known to be an important factor in forming an external image because the set of teeth affects not only the teeth themselves, but a skeletal structure of a face.

In particular, a person who has a malformed set of teeth may not only affect his or her external image, but experience inconvenience in the dietary life. Accordingly, the straightening of irregular teeth has been considered to be an important subject of treatment in dentistry. For this reason, orthodontics in the dentistry treatment has a long history, and a method or technology thereof has been remarkably developed.

The straightening of irregular teeth that has widely performed until recently was a method of attaching a bracket to the outside surface of each tooth forming a set of teeth and binding a wire, that is, a wire of a strong material in which an archwire for correcting the set of teeth has been formed, to fixed structures formed in the brackets so that the location or direction of the teeth are gradually corrected by an external physical force of the wire for a long time.

Furthermore, recently, an operation tends to increase in such a manner that the brackets are attached to the inside of a set of teeth, that is, a surface on the tongue side within the mouth of the teeth, and the wire is connected to the brackets so that a specific orthodontic operation can be performed by an external force. Furthermore, an operation using a clear aligner appliance along with a lingual appliance tends to increase.

Korean Registered Utility Model No. 20-0172086 “An Inner Bracket for Teeth Correction” has been devised. In a known bracket in which central part in the cross section of an arch wire in which an occlusal surface slot and a horizontal slot have different size are formed to go across, the occlusal surface slot and horizontal surface slot of a bracket for correcting a teeth, such as a premolar and a molar teeth and an anterior tooth, are matched with the occlusal surface so that arch wires having the same size can be used in two or more ways.

In particular, in order to attach the bracket to the surface of a tooth, the lip side of the tooth is cleaned and dried. In order to form a fine convex and concave surface in the surface, acid processing is performed on a portion to which the bracket is to be attached using an acid etching agent and washed. Accordingly, fine concave and convex parts are artificially assigned to the surface of the tooth. After the labial of the tooth is dried again, a bonding agent is first coated on the surface of the tooth, a specific amount of resin is laid on the portion of the surface of the tooth to be attached, a specific amount of resin is also applied to a bottom portion in which the bracket comes into contact with the surface of the tooth, and the resin is compressed to the accurate portion of the surface of the tooth. Accordingly, redundant resin exits to the outside, and the surface of the tooth and the bottom of the bracket are closely subjected to pressure welding. When the resin is cured by taking the sun, it adheres to the surface of the tooth. Thereafter, the redundant hardened resin is neatly removed using a tool.

### SUMMARY OF THE INVENTION

The existing method of attaching a bracket to a tooth for orthodontics has disadvantages in that it is aesthetically poorer than a bracket of resin that is aesthetically transparent or has a tooth color during straightening due to the metallic bracket, a food and drink are not well brushed by toothbrushing because a transition portion connected between the bracket and a surface of a teeth and the resin becomes rough and transferred at right angle, and thus the morbidity of a decayed tooth is high during straightening or after straightening.

Furthermore, the wire is put in the horizontal slot within the transparent bracket and the wire is ligature by transparent elastic rubber ring or a ligature wire. The remaining hard resin and a food residue remain in a portion that is slightly yellow around the transparent elastic rubber ring or ligature wire for a long time and secede a tooth. There is a possibility that the hard resin and food residue may switch to a decayed tooth after a lapse of long time.

According, there is a necessity to improve the possibility.

The present invention has been invented to improve the aforementioned problems, and the present disclosure provides an orthodontic appliance, in which can installing an orthodontic appliance by applying, to the teeth surface in particular, the adhesive covering the arch wire after installing the arch wire in a mouth.

Furthermore, the present disclosure provides an orthodontic appliance that can protect the teeth from cavities by applying the adhesive to teeth surface without existing brackets.

Furthermore, the present disclosure provides an orthodontic appliance that can prevent the adhesive from interfering with movement of the arch wire by covering the surface of the arch wire with the adhesive after coating the surface of the arch wire with a soluble coating agent.

As well as, the present invention provides an orthodontic appliance, in which can perform perfect straightening in deciduous dentition prior to adult straightening by applying a thin wire if an adult bracket cannot be settled in the application of a coating-processed arch wire and an adhesive in the case where recurrence is generated after straightening, partial fine adjustment after straightening is completed, and straightening and deciduous dentition by which an interdental space is made slowly disappear, and can simply treat the agitation of teeth and an interdental opening (widening phenomenon) attributable to a periodontal disease.

An orthodontic appliance according to the present disclosure may includes an arch wire which is formed on a trajectory corresponding to an aligned dentition of the lower or upper dentures, and is installed on the lip side or the tongue side of dentures; an anchor bracket which is fixed on both side molars of the upper dentures or both side molars of the lower dentures, and detachably anchors the arch wire; and an adhesive which is formed in a gel state, and is cured after being applied to the teeth surface of teeth to be aligned, the adhesive covering the arch wire installed on the anchor bracket so as to allow the arch wire to move when the teeth bodies of the teeth to be aligned move.

The adhesive may includes a tooth color and a tooth shape.

The coating processing of a soluble coating may be performed on the arch wire prevent the adhesive from adhering to a surface of a tooth to be attached when the adhesive is cured.

The soluble coating may includes a harmless component or a combination of harmless components.

Unlike prior art, the present invention can easily install an orthodontic appliance by applying, to the teeth surface, the adhesive covering the arch wire after installing the arch wire in a mouth.

In addition, the present invention can protect the teeth from cavities by applying the adhesive to the teeth surface without existing brackets.

Furthermore, the present invention can prevent the adhesive from interfering with movement of the arch wire by covering the surface of the arch wire with the adhesive after coating the surface of the arch wire with a soluble coating agent.

As well as, the present invention can perform perfect straightening in the case of recurrence after adult straightening and a case where an existing bracket cannot be applied because teeth are small in deciduous dentition when a tooth needs to slightly move by applying a thin wire if an adult bracket cannot be settled in the application of a coating-processed arch wire and an adhesive in the case where recurrence is generated after straightening, partial fine adjustment after straightening is completed, and straightening and deciduous dentition by which an interdental space is made slowly disappear, and can simply treat the agitation of teeth and an interdental opening (widening phenomenon) attributable to a periodontal disease, preliminary straightening prior to the prosthetic dentistry of warped teeth for prosthetic dentistry recovery, etc.

### DESCRIPTION OF THE DRAWINGS

FIG. 1 is a perspective view of the lower dentures installed an appliance according to an exemplary embodiment of the present invention.

FIG. 2 is a perspective view of the state detachable from the teeth in which an orthodontic appliance according to an exemplary embodiment of the present invention.

FIG. 3 is a perspective view of a coated arch wire according to an exemplary embodiment of the present invention.

FIG. 4 is a cross-sectional view of major parts of the orthodontic appliance according to an exemplary embodiment of the present invention.

FIG. 5 is a cross-sectional view of major parts of an orthodontic appliance according to another exemplary embodiment of the present invention.

### DETAILED DESCRIPTION OF THE EMBODIMENTS

The present invention will be described more fully hereinafter with reference to the accompanying drawings, an orthodontic appliance in which exemplary embodiments of the invention are shown. The thickness of lines, the size of elements, etc. shown in this process may have been exaggerated for the clarity of a description and for convenience' sake. Furthermore, terms described later are terms defined by taking into consideration functions in the present invention, and may be different depending on a user and an operator's intention or usage. Accordingly, such terms should be defined based on the overall contents of this specification.

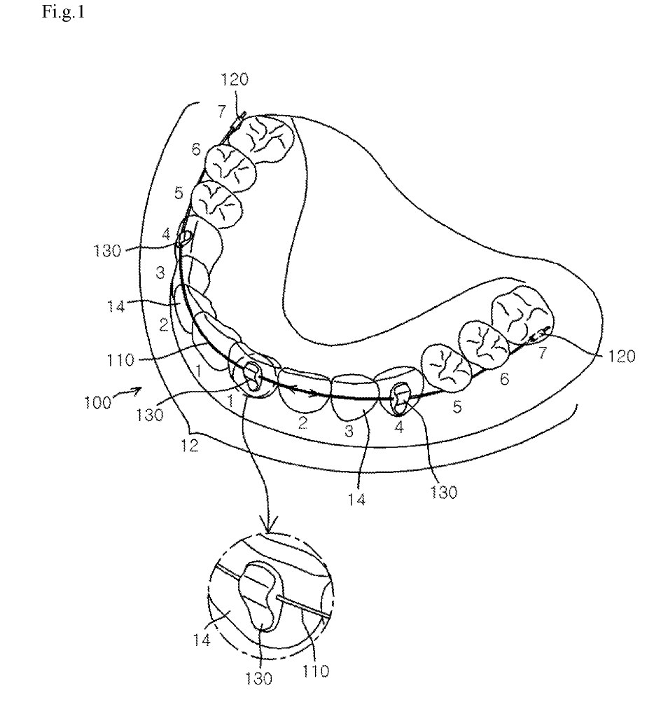

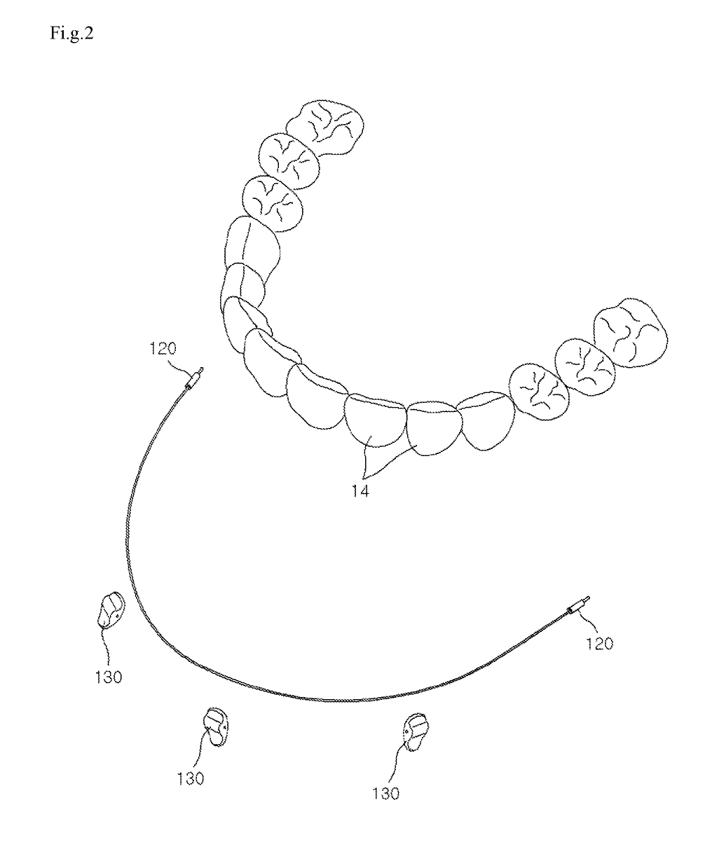

FIG. 1 is a perspective view of the lower dentures installed an appliance according to an exemplary embodiment of the present invention, and FIG. 2 is a perspective view of the state detachable from the teeth in which an orthodontic appliance according to an exemplary embodiment of the present invention.

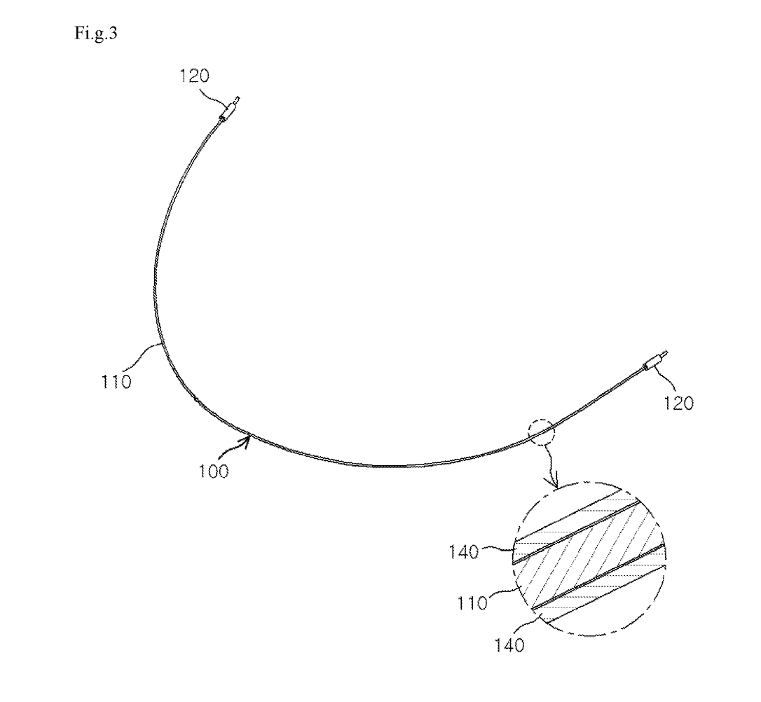

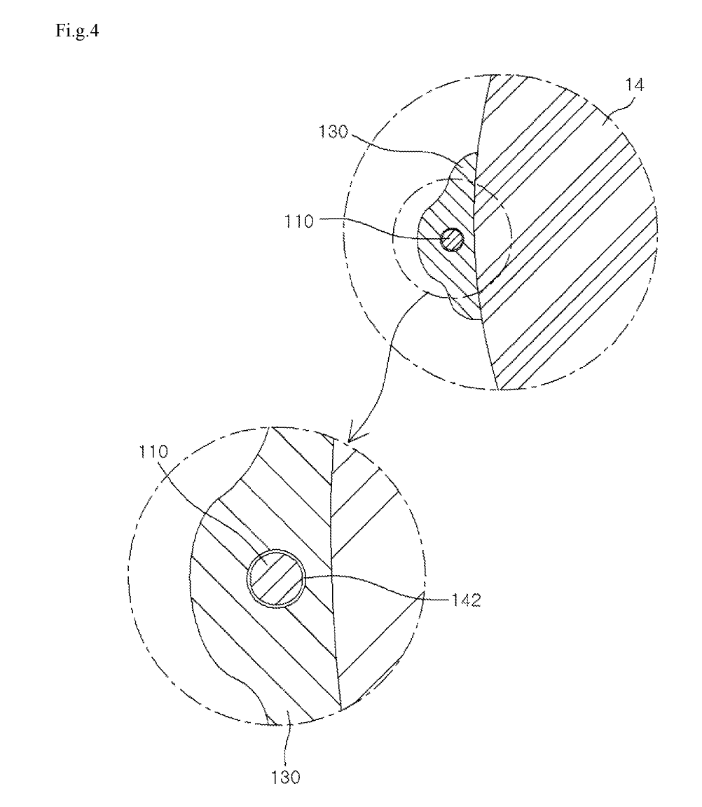

FIG. 3 is a perspective view of a coated arch wire according to an exemplary embodiment of the present invention, and FIG. 4 is a cross-sectional view of major parts of an orthodontic appliance according to an exemplary embodiment of the present invention.

Referring to FIGS. 1 to 4, the orthodontic appliance 100 according to an exemplary embodiment of the present invention includes an arch wire 110, anchor bracket 120 and an adhesive 130.

The arch wire 110 which is formed an a trajectory corresponding to an aligned dentition 14 of the lower dentures 12 (not shown) or upper dentures, and is installed on the lip side or the tongue side of the dentures 12.

For convenience sake, the arch wire 110 is provided in the lip side for the straightening of the tooth 14 of the lower dentures 12.

Furthermore, the arch wire 110 may be applied in the state in which a specific tooth 14 has been extracted or not extracted.

Of course, the arch wire 110 may be equally applied to the upper denture.

In this case, the upper dentures refers to a denture of a plurality of teeth provided in the upper jaw. Furthermore, the lower dentures 12 refers to a plurality of the teeth 14 provided in the lower jaw.

Furthermore, the arch wire 110 is provided over all of the teeth 14 of the same set of teeth that require straightening. The arch wire 110 may be different in the type and diameter or thickness of metal of the arch wire 110 depending on the degree of straightening of the tooth 14, that is, the direction of teeth bodies movement. The arch wire 110 functions to straighten a set of corresponding teeth 14 by assigning lateral pressure or a distortion force to the tooth 14 corresponding to the straightening of irregular teeth.

Various materials may be applied to the arch wire 110, and the arch wire 110 may be made of a shape memory alloy.

Meanwhile, the anchor bracket 120 are fixed on both side molars of the upper dentures or both side molars of the lower dentures 12, and detachably anchors the arch wire 110 In particular, the anchor bracket 120 are provided in the teeth 14 at corners on both sides of the upper dentures or corners on both sides of the lower dentures 12, and thus function to insert corners on both sides of the arch wire 110 in such a way as to be detachably.

For convenience sake, the anchor bracket 120 has been disposed in the molar part of a tooth 14 located at the corner on one side of the lower dentures 12. Of course, the anchor bracket 120 may be modified in shape in various ways and may couple one side of the arch wire 110 in various ways.

Furthermore, the adhesive 130 covering the arch wire 110 and adhere to a teeth surface of the teeth 14 that is the subject of straightening, thus functions to permit a movement of the arch wire 110 in its axial direction when the body of the teeth 1l4 that is the subject of aligned moves. That is, the adhesive 130 adhere to the surface of the teeth, maintain the shape of the arch wire 110, and permit a movement of the arch wire 110 in its axial direction as a set of teeth moves.

More specifically, the adhesive 130 is formed in a gel state, and is cured after being applied to the teeth surface of teeth 14 to be aligned, the adhesive 130 covering the arch wire 110 installed on the anchor bracket 120 so as to allow the arch wire 110 to move when the teeth bodies of the teeth 14 to be aligned move.

In particular, the adhesives 130 can protect the teeth 14 because they adhere to the teeth surface of the teeth 14 in the state in which the teeth surface of the teeth 14 has not been polished. Furthermore, since the teeth surface of the teeth 14 is not polished, a decayed tooth is not easily generated in a portion to which the adhesive 130 is attached.

Furthermore, for an aesthetic sense, the adhesive 130 may includes a tooth 14 color and a tooth 14 shape. Of course, the adhesive 130 may be modified in various ways.

Furthermore, the adhesive 130 obviates displeasure when resin, etc, touches a gum, and is made of a harmless material.

As a result, the adhesive 130 plays the role of an existing bracket in the teeth of the upper dentures (not shown) or in the middle tooth portion of the lower dentures 12. In particular, the arch wire 110 may be applied in a circle or polygon shape.

Meanwhile, the adhesive 130 may adhere to a surface of the arch wire 110 in a process of the adhesive being cured. In this case, a movement of the arch wire 110 may be restricted according to a movement of a teeth body.

Accordingly, the coating processing of a soluble coating agent 140 may be performed on the arch wire 110 prevent the adhesive 130 from being attached to a surface of the arch wire 110 when the adhesive 130 is cured.

In this case, the coating processing of the soluble coating agent 140 is performed on the entire surface of the arch wire 110. Furthermore, the adhesive 130 covering the arch wire 110 with the adhesive after coating of the arch wire with a soluble coating agent 140 and then adheres to the teeth surface.

In particular, the soluble coating agent 140 is characterized in that it is dissolved by a specific component, etc. of saliva after a lapse of some time, and it is innoxuous. That is, the soluble coating 140 is a harmless component or a combination of harmless components.

In this case, the soluble coating agent 140 is dissolved after the adhesive 130 is cured. Accordingly, the adhesive 130 and the arch wire 110 are not bonded and a space 142 is formed between them, so the arch wire 110 can move while being covered by the adhesive 130.

Furthermore, the adhesive 130 is filled between the teeth surface of the tooth 14 and the arch wire 110. Accordingly, interference with the tooth 14 is prevented when the arch wire 110 moves because the arch wire 110 is spaced apart from the tooth surface of the tooth 14.

Furthermore, the attachment of a food and drink is difficult, toothbrushing is easy, and a decayed tooth is prevented because the transition portion of the tooth surface and the adhesive 130 is smooth.

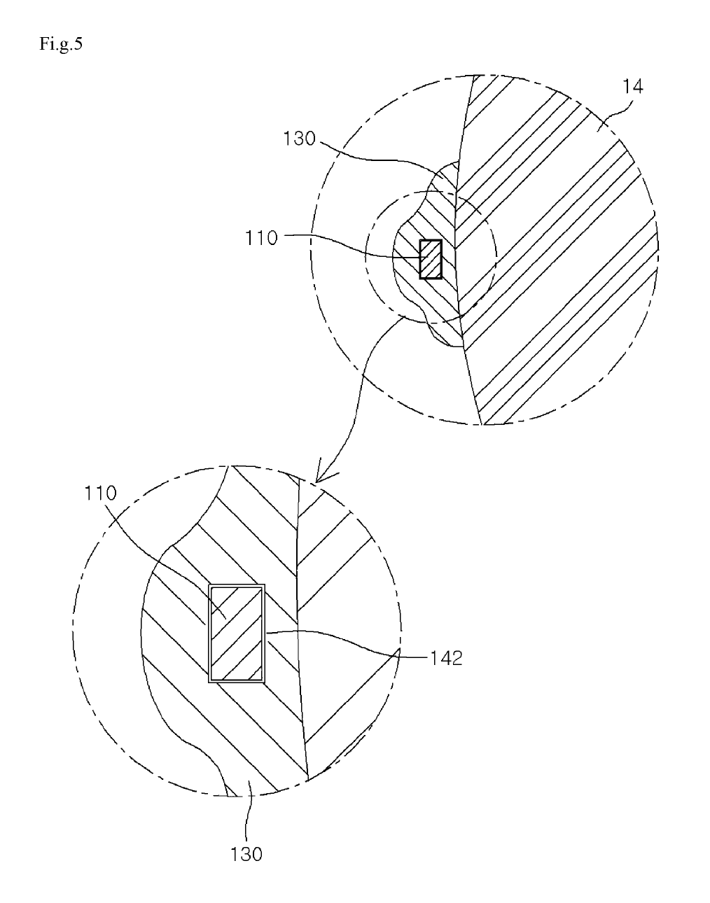

FIG. 5 is a cross-sectional view of major parts of an orthodontic appliance according to another exemplary embodiment of the present invention.

Referring to FIG. 5, the orthodontic appliance 100 according to another embodiment of the present invention includes an arch wire 110, anchor brackets 120 and an adhesive 130, as described above.

As well as, the arch wire 110 has a cross section of a rectangular shape and can improve the orthodontic force of the tooth 14.

Reference numerals that are not described are substituted with the aforementioned reference numerals.

While the present invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims. Accordingly, the scope of the present disclosure shall be determined only according to the attached claims.

1. An orthodontic appliance, comprising:
an arch wire formed on a trajectory corresponding to an aligned dentition of the lower or upper dentures, and installed on the lip side or the tongue side of the dentures;
an anchor bracket fixed on both sides molars of the upper dentures or both sides molars of the lower dentures, and detachably anchoring the arch wire; and
an adhesive formed in a gel state, and cured after being applied to the teeth surface of teeth to be aligned, the adhesive covering the arch wire installed on the anchor bracket so as to allow the arch wire to move when the teeth bodies of the teeth to be aligned move.

2. The orthodontic appliance of claim 1, wherein the adhesive has a tooth color and a tooth shape.

3. The orthodontic appliance of claim 1, wherein a coating processing of a soluble coating agent is performed on the arch wire to prevent the adhesive from adhering to a surface of the arch wire when the adhesive is cured.

4. The orthodontic appliance of claim 3, wherein the soluble coating agent consists of a harmless component or a combination of harmless components.

5. The orthodontic appliance of claim 2, wherein a coating processing of a soluble coating agent is performed on the arch wire to prevent the adhesive from adhering to a surface of the arch wire when the adhesive is cured.
